(19) United States
(12) Patent Application Publication
(10) Pub. No.: US 2011/0021687 A1
(43) Pub. Date: Jan. 27, 2011

(54) POLYAMIDE NANOCOMPOSITES WITH HYPER-BRANCHED POLYETHYLENEIMINES

(75) Inventors: Sachin Jain, Mannheim (DE); Claus Gabriel, Griesheim (DE); Philippe Desbois, Edingen-Neckarhausen (DE); Dirk Opfermann, Mannheim (DE); Peter Eibeck, Speyer (DE); Bernd Bruchmann, Freinsheim (DE); Martin Klatt, Mannheim (DE)

Correspondence Address: CONNOLLY BOVE LODGE & HUTZ LLP, P.O. BOX 2207, WILMINGTON, DE, 19899, US

(73) Assignee: BASF SE, Ludwigshafen (DE)

(21) Appl. No.: 12/933,305

(22) PCT Filed: Mar. 18, 2009
(86) PCT No.: PCT/EP2009/053166

§ 371 Date: Sep. 17, 2010

(30) Foreign Application Priority Data
Mar. 18, 2008 (EP) 08152904.2

(51) Int. Cl. C08K 3/40; C08K 3/36

(52) U.S. Cl. 524/494; 524/493

(57) ABSTRACT

The invention relates to thermoplastic molding compositions comprising the following components:
A) at least one thermoplastic polyamide,
B) at least one hyperbranched polyethyleneimine,
C) at least one amorphous oxide and/or oxide hydrate of at least one metal or semimetal with a number-average diameter of the primary particles of from 0.5 to 20 nm.

The invention further relates to the use of the components B) and C) mentioned, for improving the flowability and/or thermal stability of polyamides, to the use of the molding compositions for the production of fibers, of foils, and of moldings of any type, and also to the resultant fibers, foils, and moldings.

The invention relates to thermoplastic molding compositions comprising the following components:
A) at least one thermoplastic polyamide,
B) at least one hyperbranched polyethyleneimine,
C) at least one amorphous oxide and/or oxide hydrate of at least one metal or semimetal with a number-average diameter of the primary particles of from 0.5 to 20 nm.

The invention further relates to the use of the components B) and C) mentioned, for improving the flowability and/or thermal stability of polyamides, to the use of the molding compositions for the production of fibers, of foils, and of moldings of any type, and also to the resultant fibers, foils, and moldings.

Polyethyleneimines are usually obtained by catalyzed polymerization from ethylene-imines (aziridines). The preparation of these polymers is known to the person skilled in the art and described by way of example in Ullmann's Encyclopedia of Industrial Chemistry, “Aziridines”, electronic release (published on Dec. 15, 2006), chapter 3.

The flow of thermoplastic polyesters and polycarbonates is generally improved by adding lubricants (see Gächter, Müller: Kunststoffadditive [Plastics additives], 3rd edition, pp. 479, 486-488, Carl Hanser Verlag 1989). Disadvantages here are in particular exudation of the additives during processing.

EP-A 1 424 360 describes the use of terminal-polyfunctional polymeric compounds from the group of the polyesters, polyglycerols, and polyethers, for lowering melt viscosity in thermoplastic polycondensates.

WO 2006/42705 describes thermoplastic molding compositions based on polyamides and on highly branched polycarbonates. This WO 2006/42705 also discloses that lamellar or acicular nanofillers can increase strength. However, a disadvantage is impairment of flowability through addition of these fillers.

WO 2004/041937 discloses thermoplastic molding compositions based on semicrystalline polyamide, and on amorphous polyamide, and also on specific branched graft copolyamides. The polyamide molding compositions are set to have low melt viscosity even at high filler levels, using conventional reinforcing materials or fillers.

WO 2006/122602 describes molding compositions based on thermoplastic polyamide which also comprises at least one polyamide oligomer having linear or branched chain structure. The polyamide molding compositions are said to have markedly improved flowability. The application is aimed at conductive thermoplastics which are obtained using appropriate fillers, such as carbon black or else carbon nanofibrils. WO 2006/122602 indicates that the addition of small, particulate fillers leads, exactly like the addition of glass fibers, to a disadvantageous reduction of the flowability of the polyamide melt. The situation is improved by addition of polyamide oligomers.

Although there are, therefore, known highly branched or hyperbranched organic compounds for improving the flowability of polyamide melts, the lowering of melt viscosity results from an alternation of molecular structure, in particular degradation of molecular weight. This results in disadvantageous impairment of mechanical properties, in particular in relation to impact resistance, but also in relation to strength, in particular breaking strength.

The unpublished PCT/EP2008/050062 discloses that addition of small amounts of certain metal oxides or semimetal oxides or the corresponding hydrates with particle size up to 10 nm, obtainable from a sol-gel synthesis, can achieve a reduction of melt viscosity in polyamides while avoiding the disadvantages mentioned of impairment of mechanical properties.

However, the degree of reduction of melt viscosity, seen in relation to mechanical properties, is not sufficient for all applications and for all types and molecular weights of polyamide.

It was an object of the present invention to avoid the disadvantages mentioned of the prior art. The intention was to provide polyamide molding compositions, in particular filled polyamide molding compositions, with reduced melt viscosity together with advantageous mechanical properties. A particular intention was that impact resistance and breaking strength achieve at least the level of the molding composition without flow-improvement aids, while flowability is improved. Another object of the present invention was to provide polyamide molding compositions with improved thermal stability. A further intention was to minimize the amounts of the additive(s) in the molding compositions. The additives were intended not to exude during processing.

The thermoplastic molding compositions mentioned at the introduction have accordingly been found, as also have their use, and the moldings, foils, and. fibers that can be obtained from them. Preferred embodiments of the invention can be found in the description and in the subclaims. Combinations of preferred embodiments are within the scope of the present invention.

According to the invention, the thermoplastic molding compositions comprise the following components:
A) at least one thermoplastic polyamide,
B) at least one hyperbranched polyethyleneimine,
C) at least one amorphous oxide and/or oxide hydrate of at least one metal or semimetal with a number-average diameter of the primary particles of from 0.5 to 20 nm.

The thermoplastic molding compositions preferably comprise from 50 to 99.9% by weight of component A), from 0.05 to 30% by weight of component B), and from 0.05 to 20% by weight of component C), where the total of the percentages by weight of components A) to C) is 100% by weight.

The abovementioned preferred range of percentages by weight comprises the thermoplastic molding compositions of the invention in the narrower sense and also what are known as masterbatches as intermediate products in which components B) and C) are provided in greatly increased concentration in A).

It is preferable that the thermoplastic molding compositions comprise components B) and C) in a ratio by weight B/C of from 0.1 to 4, preferably from 0.2 to 2, in particular from 0.3 to 0.8.

In one particularly preferred embodiment, the inventive molding compositions comprise from 85 to 99.9% by weight of component A), from 0.05 to 10% by weight of component B), and from 0.05 to 5% by weight of component C), where the total of the percentages by weight of components A) to C) is 100% by weight. It is particularly preferable that the molding compositions of the invention here comprise from 93 to 99.9% by weight of component A), from 0.05 to 5% by weight of component B), and from 0.05 to 2% by weight of component C), where the total of the percentages by weight of components A) to C) is 100% by weight.

Component A

According to the invention, the thermoplastic molding compositions comprise at least one thermoplastic polyamide as component A).

The viscosity number of the polyamides of the inventive molding compositions is generally from 70 to 350 ml/g, preferably from 70 to 200 ml/g, determined in a 0.5% strength by weight solution in 96% strength by weight sulfuric acid at 25° C. to ISO 307.

Semicrystalline or amorphous resins whose molecular weight (weight-average) is at least 5000 are preferred, examples being those described in the U.S. Pat. Nos.2,071,250, 2,071,251, 2,130,523, 2,130,948, 2,241,322, 2,312,966, 2,512,606, and 3,393,210.

It is preferable to use polyamides which derive from lactams having from 7 to 13 ring members, for example polycaprolactam, polycaprylolactam, and polylaurolactam, and also polyamides obtained via reaction of dicarboxylic acids with diamines.

Dicarboxylic acids that can be used are alkanedicarboxylic acids having from 6 to 12, in particular from 6 to 10 carbon atoms, and aromatic dicarboxylic acids. Just a few acids that may be mentioned here are adipic acid, azelaic acid, sebacic acid, dodecanedioic acid and terephthalic and/or isophthalic acid.

Particularly suitable diamines are alkanediamines having from 6 to 12, in particular from 6 to 8, carbon atoms, and also m-xylylenediamine, di(4-aminophenyl)methane, di-(4-aminocyclohexyl)methane, 2,2-di(4-aminophenyl)propane, 2,2-di(4-aminocyclo-hexyl)propane, or 1,5-diamino-2-methylpentane.

Preferred polyamides are polyhexamethyleneadipamide, polyhexamethylene-sebacamide, and polycaprolactam, and also nylon-6/6,6 copolyamides, in particular having from 5 to 95% by weight content of caprolactam units.

Other suitable polyamides are obtainable from ω-aminoalkylnitriles, such as aminocapronitrile (PA 6) and adipodinitrile with hexamethylenediamine (PA 66), by what is known as direct polymerization in the presence of water, as described by way of example in DE-A 10313681, EP-A 1198491, and EP 922065.

Mention may also be made of polyamides obtainable by way of example via condensation of 1,4-diaminobutane with adipic acid at an elevated temperature (nylon-4,6). Preparation processes for polyamides of said structure are described by way of example in EP-A 38 094, EP-A 38 582, and EP-A 39 524.

Other suitable polyamides are those obtainable via copolymerization of two or more of the abovementioned monomers, or a mixture of a plurality of polyamides, in any desired mixing ratio.

Semiaromatic copolyamides, such as PA 6/6T and PA 66/6T, have moreover proven particularly advantageous, the triamine content of these being less than 0.5% by weight, preferably less than 0.3% by weight (see ER-A 299 444).

The processes described in EP-A 129 195 and 129 196 can be used to prepare the preferred semiaromatic copolyamides having low triamine content.

The preferred semiaromatic copolyamides A) comprise, as component a₁), from 40 to 90% by weight of units which derive from terephthalic acid and from hexamethylene-diamine, based on component A). A small proportion of the terephthalic acid, preferably not more than 10% by weight of the entire aromatic dicarboxylic acids used, can be replaced by isophthalic acid or other aromatic dicarboxylic acids, preferably those in which the carboxy groups are in para position.

The semiaromatic copolyamides comprise, alongside the units which derive from terephthalic acid and from hexamethylenediamine, units which derive from ε-caprolactam (a₂), and/or units which derive from adipic acid and hexamethylene-diamine (a₃).

The proportion of units which derive from E-caprolactam is at most 50% by weight, preferably from 20 to 50% by weight, in particular from 25 to 40% by weight, while the proportion of units which derive from adipic acid and hexamethylenediamine is up to 60% by weight, preferably from 30 to 60% by weight, and in particular from 35 to 55% by weight, based in each case on component A).

The copolyamides can also comprise not only units of ε-caprolactam but also units of adipic acid and hexamethylenediamine; in this case, care has to be taken that the proportion of units free from aromatic groups is at least 10% by weight, preferably at least 20% by weight, based on component A). The ratio of the units which derive from ε-caprolactam and from adipic acid and hexamethylenediamine here is not subject to any particular restriction.

Polyamides which have proven particularly advantageous for many applications are those having from 50 to 80% by weight, in particular from 60 to 75% by weight, of units which derive from terephthalic acid and from hexamethylenediamine (units a₁)) and from 20 to 50% by weight, preferably from 25 to 40% by weight, of units which derive from ε-caprolactam (units a₂)), based in each case on component A).

The inventive semiaromatic copolyamides A) can also comprise, alongside the units a₁) to a₃) described above, an amount which is preferably not more than 15% by weight, in particular not more than 10% by weight, of the other polyamide units (a₄) known from other polyamides. These units can derive from dicarboxylic acids having from 4 to 16 carbon atoms and from aliphatic or cycloaliphatic diamines having from 4 to 16 carbon atoms, and also from aminocarboxylic acids and, respectively, corresponding lactams having from 7 to 12 carbon atoms. Monomers of these types that may be mentioned here merely as examples are suberic acid, azelaic acid, sebacic acid, or isophthalic acid as representatives of the dicarboxylic acids, 1,4-butanediamine, 1,5-pentane-diamine, piperazine, 4,4′-diaminodicyclohexylmethane, and 2,2-(4,4′-diaminodicyclo-hexyl)propane or 3,3′-dimethyl-4,4′-diaminodicyclohexylmethane as representatives of the diamines, and caprylolactam, enantholactam, omega-aminoundecanoic acid, and laurolactam as representatives of lactams and, respectively, aminocarboxylic acids.

The melting points of the semiaromatic copolyamides A) are in the range from 260 to more than 300° C., and this high melting point is also associated with a high glass transition temperature which is generally more than 75° C., in particular more than 85° C.

Binary copolyamides based on terephthalic acid, hexamethylenediamine, and ε-caprolactam have melting points in the region of 300° C. and a glass transition temperature of more than 110° C. if their contents of units which derive from terephthalic acid and from hexamethylenediamine are about 70% by weight.

Binary copolyamides based on terephthalic acid, adipic acid, and hexamethylene-diamine (HMD) achieve melting points of 300° C. and more even at lower contents of units derived from terephthalic acid and from hexamethylenediamine, of about 55% by weight, but here the glass transition temperature is not quite as high as for binary copolyamides which comprise ε-caprolactam instead of adipic acid or adipic acid/HMD.

The following list, which is not comprehensive, comprises the polyamides A) mentioned and other polyamides A) for the purposes of the invention, and the monomers comprised.

AB polymers:

| | |
|---|---|
| PA 4 | Pyrrolidone |
| PA 6 | ε-Caprolactam |
| PA 7 | Ethanolactam |
| PA 8 | Caprylolactam |
| PA 9 | 9-Aminopelargonic acid |
| PA 11 | 11-Aminoundecanoic acid |
| PA 12 | Laurolactam |

AA/BB polymers:

| | |
|---|---|
| PA 46 | Tetramethylenediamine, adipic acid |
| PA 66 | Hexamethylenediamine, adipic acid |
| PA 69 | Hexamethylenediamine, azelaic acid |
| PA 610 | Hexamethylenediamine, sebacic acid |
| PA 612 | Hexamethylenediamine, decanedicarboxylic acid |
| PA 613 | Hexamethylenediamine, undecanedicarboxylic acid |
| PA 1212 | 1,12-Dodecanediamine, decanedicarboxylic acid |
| PA 1313 | 1,13-Diaminotridecane, undecanedicarboxylic acid |
| PA 6T | Hexamethylenediamine, terephthalic acid |
| PA 9T | Nonyldiamine/terephthalic acid |
| PA MXD6 | m-Xylylenediamine, adipic acid |
| PA 6I | Hexamethylenediamine, isophthalic acid |
| PA 6-3-T | Trimethylhexamethylenediamine, terephthalic acid |
| PA 6/6T | (see PA 6 and PA 6T) |
| PA 6/66 | (see PA 6 and PA 66) |
| PA 6/12 | (see PA 6 and PA 12) |
| PA 66/6/610 | (see PA 66, PA 6 and PA 610) |
| PA 6I/6T | (see PA 6I and PA 6T) |
| PA PACM 12 | Diaminodicyclohexylmethane, laurolactam |
| PA 6I/6T/PACM | as PA 6I/6T + diaminodicyclohexylmethane |
| PA 12/MACMI | Laurolactam, dimethyldiaminodicyclohexylmethane, |
| | isophthalic acid |
| PA 12/MACMT | Laurolactam, dimethyldiaminodicyclohexylmethane, |
| | terephthalic acid |
| PA PDA-T | Phenylenediamine, terephthalic acid |

However, it is also possible to use a mixture of the above polyamides.

Component B

According to the invention, the thermoplastic molding compositions comprise, as component B), at least one hyperbranched polyethyleneimine. The molding compositions of the invention preferably comprise from 0.05 to 30% by weight, in particular from 0.05 to 10% by weight, and particularly preferably from 0.1 to 4% by weight, of at least one hyperbranched polyethyleneimine.

For the purposes of the present invention, the “hyperbranched” feature means that the degree of branching DB of the polymers concerned, defined as DB (%)=100×(T+Z)/(T+Z+L), where T is the average number of terminally bonded monomer units, Z is the average number of monomer units generating branching, and L is the average number of linearly bonded monomer units in the macromolecules of the respective substances, is from 10 to 98%, preferably from 25-90%, and particularly preferably from 30 to 80%.

Hyperbranched polymers, also termed highly branched polymers, differ from dendrimers. Dendrimers are polymers having perfectly symmetrical structure, and can be prepared starting from a central molecule via controlled stepwise linkage of respectively two or more di- or polyfunctional monomers to each previously bonded monomer. Each linkage step therefore multiplies the number of monomer end groups (and therefore of linkages), giving polymers with dendritic structures, ideally spherical, the branches of which respectively comprise exactly the same number of monomer units. By virtue of this perfect structure, the polymer properties are in many cases advantageous, examples of those found being low viscosity and high reactivity due to the large number of functional groups at the surface of the sphere. However, the factor complicating the preparation process is that each linkage step requires the introduction and subsequent removal of protective groups, and operations are required to remove contamination. Dendrimers are therefore usually only prepared on a laboratory scale.

However, highly branched or hyperbranched polymers can be prepared using industrial-scale processes. For the purposes of the present invention, the term hyperbranched comprises the term highly branched and is used hereinafter to represent both terms. Hyperbranched polymers also have linear polymer chains and unequal polymer branches alongside perfect dendritic structures, but this does not substantially impair polymer properties in comparison with those of perfect dendrimers.

The (non-dendrimeric) hyperbranched polymers of the invention differ from dendrimers in the degree of branching defined above. In the context of the present invention, the polymers are “dendrimeric” if their degree of branching DB=from 99.9-100%. A dendrimer therefore has a maximum possible number of branching points, and this number can be achieved only via a highly symmetrical structure. See also H. Frey et al., Acta Polym. 1997, 48, 30 for the definition of “degree of branching”.

For the purposes of the present invention, therefore, hyperbranched polymers are substantially non-crosslinked macromolecules which have both structural and molecular non-uniformity.

For the purposes of the present invention, it is preferable to use highly functional hyperbranched polyethyleneimines B).

For the purposes of this invention, a highly functional hyperbranched polyethyleneimine is a product which has not only the secondary and tertiary amino groups which form the main structure of the polymer but also has an average of at least three, preferably at least six, particularly preferably at least ten, terminal or pendant functional groups. The functional groups are preferably primary amino groups. The number of the terminal or pendant functional groups is not in principle subject to any upper restriction, but products having a very large number of functional groups can have undesired properties, such as high viscosity or poor solubility. It is preferable that the highly functional hyperbranched polyethyleneimines of the present invention do not have more than 500 terminal or pendant functional groups, in particular not more than 100 terminal or pendant groups.

For the purposes of the present invention, polyethyleneimines are either homo- or copolymers, obtainable by way of example by the processes in Ullmann's Encyclopedia of Industrial Chemistry, “Aziridines”, electronic release (article published on Dec. 15, 2006), or according to WO-A 94/12560.

The homopolymers are preferably obtainable via polymerization of ethyleneimine (aziridine) in aqueous or organic solution in the presence of compounds which cleave to give acids, or of acids or Lewis acids. These homopolymers are branched polymers which generally comprise primary, secondary, and tertiary amino groups in a ratio of about 30%:40%:30%. The distribution of the amino groups can be determined by ¹³C NMR spectroscopy.

The comonomers used preferably comprise compounds which have at least two amino functions. Suitable comonomers which may be mentioned as examples are alkylene-diamines having from 2 to 10 carbon atoms in the alkylene radical, preferably ethylene-diamine or propylenediamine. Other suitable comonomers are diethylenetriamine, triethylenetetramine, tetraethylenepentamine, dipropylenetriamine, tripropylene-tetramine, dihexamethylenetriamine, aminopropylethylenediamine, and bisamino-propylethylenediamine.

The average (weight-average) molar mass of polyethyleneimines is usually in the range from 100 to 3 000 000 g/mol, preferably from 800 to 2 000 000 g/mol.

The polyethyleneimines obtained by catalyzed polymerization of aziridines here usually have weight-average molar mass in the range from 800 to 50 000 g/mol, in particular from 1000 to 30 000 g/mol. Relatively high-molecular-weight polyethyleneimines can be obtained in particular by reaction of the abovementioned polyethyleneimines with difunctional alkylation compounds, for example chloromethyloxirane or 1,2-dichloro-ethane, or by ultrafiltration of polymers of broad molecular-weight distribution, as described for example in EP-A 873371 and EP-A 1177035, or by crosslinking.

Other polyethyleneimines suitable as component B) are crosslinked polyethyleneimines obtainable by reacting polyethyleneimines with bi- or polyfunctional crosslinking agents having, as functional group, at least one halohydrin, glycidyl, aziridine, or isocyanate units, or one halogen atom. Examples which may be mentioned are epichlorohydrin, and bischlorohydrin ethers of polyalkylene glycols having from 2 to 100 units of ethylene oxide and/or of propylene oxide, and also the compounds listed in DE-A 19 93 17 20 and U.S. Pat. No. 4,144,123. Processes for preparing crosslinked polyethylene-imines are known inter alia from the abovementioned publications, and also EP-A 895 521 and EP-A 25 515. Crosslinked polyethyleneimines usually have average molar mass of more than 20 000 g/mol.

Grafted polyethyleneimines are also suitable as component B), and the grafting reagents used here may be any of the compounds which can react with the amino and/or imino groups of the polyethyleneimines. Suitable grafting agents and processes for preparing_{:}grafted polyethyleneimines are found in EP-A 675 914, for example.

Polyethyleneimines which are similarly suitable are amidated polymers, which are usually obtainable by reaction of polyethyleneimines with carboxylic acids, or with their esters or anhydrides, of carboxamides or with carbonyl halides. As a function of the proportion of the amidated nitrogen atoms in the polyethyleneimine chain, the amidated polymers can subsequently be crosslinked by the crosslinking agents mentioned. It is preferable here that up to 30% of the amino functions are amidated, thus leaving a sufficient number of primary and/or secondary nitrogen atoms available for any crosslinking reaction that follows.

Alkoxylated polyethyleneimines are also suitable and by way of example are obtainable by reaction of polyethyleneimine with ethylene oxide and/or propylene oxide and/or butylene oxide. These alkoxylated polymers can then also be crosslinked.

Other polyethyleneimines suitable as component B) that may be mentioned are polyethyleneimines containing hydroxy groups and amphoteric polyethyleneimines (incorporating anionic groups), and also lipophilic polyethyleneimines, which are generally obtained via incorporation of long-chain hydrocarbon radicals into the polymer chain. Processes for the preparation of these polyethyleneimines are known to the person skilled in the art, and no further details need therefore be given in this connection.

Component (B) can be used undiluted or as solution, in particular as aqueous solution.

The weight-average molar mass of component B), determined by light scattering, is preferably from 800 to 50 000 g/mol, particularly preferably from 1000 to 40 000 g/mol, in particular from 1200 to 30 000 g/mol. Average (weight-average) molar mass is preferably determined by means of gel permeation chromatography using pullulan as standard in aqueous solution (water; 0.02 mol/l of formic acid; 0.2 mol/l of KCl).

For the purposes of the present invention, the glass transition temperature of component B) is preferably below 50° C., particularly preferably below 30° C., and in particular below 10° C.

An advantageous amine number determined to DIN 53176 for component B) is in the range from 50 to 1000 mg KOH/g. Component B) advantageously has an amine number of from 100 to 900 mg KOH/g to DIN 53176, very preferably from 150 to 800 mg KOH/g.

Component C

According to the invention, the thermoplastic molding compositions comprise at least one amorphous oxide and/or oxide hydrate of at least one metal or semimetal with a number-average diameter of the primary particles of from 0.5 to 20 nm.

Amorphous means here that the oxides and/or oxide hydrates C) of the thermoplastic molding compositions of the invention are in essence non-crystalline, preferably completely non-crystalline. Accordingly, silicates in the mineralogical sense, in particular phyllosilicates, cannot be used as component C) for the present invention. The oxides and/or oxide hydrates of the present invention are obtained synthetically, preferably by solution-chemistry processes.

Processes for the preparation of suitable amorphous oxides and/or oxide hydrates are in principle known to the person skilled in the art. The oxides and/or oxide hydrates are preferably formed from a starting compound comprising at least one metal and/or semimetal M, by hydrolysis, thus forming an oxide and/or oxide hydrate by polycondensation. In the course of the polycondensation reaction, the oxides and/or oxide hydrates are formed in particulate form, the initial product being what are known as primary particles. As a function of reaction conditions, these are either obtained in the form of a colloidal solution of particles (hereinafter termed sol) or the primary particles crosslink fairly extensively with one another to produce what is known as a gel, in which, however, it is still possible to discern isolated primary particles.

The reaction conditions control the opposing processes of growth of the primary particles and their crosslinking to one another, and are known in principle to the person skilled in the art. If the pH selected for the polycondensation reaction is smaller than 7, a gel is often formed. If a pH greater than 7 is selected, in the absence of salts, sols are often formed (colloidal solutions of primary particles). Particular parameters which effect the course of the reaction and therefore the formation of the primary particles and formation of gels are: structure of the starting compound, solvent, pH, auxiliaries, catalysts, and temperature. Since the thermoplastic molding compositions of the invention comprise an oxide and/or oxide hydrate with a particle size of the primary particles of from 0.5 to 20 nm, the reaction should be controlled in such a way as to avoid any substantial agglomeration or the growth of the primary particles beyond the range mentioned. Appropriate methods for conduct of the reaction are known to the person skilled in the art and can be found in conventional textbooks about sol-gel chemistry.

Metals and/or semimetals that can be used are those of capable of forming oxides and/or oxide hydrates from starting compounds comprising the metal and/or semimetal, in the presence of protic solvents, in particular water, i.e. those metals and/or semimetals M for which hydrolyzable and polycondensable starting compounds are known or accessible, i.e. obtainable using known methods. Examples of suitable metals and/or semimetals M are Si, Ti, Fe, Ba, Zr, Zn, Al, Ga, In, Sb, Bi, Cu, Ge, Hf, La, Li, Nb, Na, Ta, Y, Mo, V, and Sn. The metal and/or semimetal M is preferably selected from Si, Ti, and Ba, and is in particular Si.

A process for the preparation of component C) preferably comprises the following steps:
at least one starting compound is provided, together with a protic solvent and, if appropriate, with further additives;
the starting compound is hydrolyzed, and a polycondensation reaction proceeds here, giving component C);
if appropriate, the solvent is removed from component C).

To prepare the thermoplastic molding compositions of the invention, component C) is brought into contact with component A) or with a precursor of component A), preferably being homogeneously dispersed in component A).

In one first preferred embodiment, component C) is obtainable from a sol.

For the purposes of the present invention, a sol is a colloidal solution of primary particles mainly present in non-agglomerated form, in particular being in essence non-agglomerated, i.e. in essence isolated. For the purposes of the present invention, the sols are in essence stable disperse systems, i.e. stable over a period of a plurality of minutes, preferably a plurality of hours, in particular a plurality of days. Colloidal solution means here primary particles dispersed in colloidal form in a dispersion medium.

Solvent here means the dispersion medium, i.e. the continuous liquid phase, in which the particles are present in the colloidal state.

Processes for preparation of the sols defined above are known to the person skilled in the art and are described by way of example in Iler, Ralph K. “The Chemistry of Silica”, chapter 4: “Colloidal Silica-Concentrated Sols”, John Wiley & Sons, New York, 1979, ISBN:0-471-02404-X, pages 331-343.

Among the processes listed the publication for the preparation of sols, in particular of sols based on SiO₂, the following are preferred:
neutralization of soluble silicates by acids
electrodialysis
ion exchange
hydrolysis of precursors comprising the metal and/or semimetal.

In one particularly preferred embodiment, the sols are obtained via an ion-exchange process. In the ion-exchange process, at least one precursor, in particular sodium silicate, is subjected to ion exchange, with the use of an ion-exchanger resin being preferred here, and is reacted to give sols and, if appropriate, gels of oxides and/or of oxide hydrates of metals and/or semimetals. These processes are described by way of example in the abovementioned reference on pages 333 to 334 under “Ion Exchange”.

The sols of the present invention can, as a result of the preparation process, comprise contaminates attributable to other metals, such as Na, K, and/or Al.

It is preferable that component C) is in a form obtained from a sol when it is brought into contact with component A), and it is particularly preferable here that the oxide and/or oxide hydrate comprised in the sol is, prior to use in a suitable form, removed from the solvent, in particular via drying by means of conventional drying processes known to the person skilled in the art. It is particularly preferable that component C) is in particulate form without solvent when it is mixed with component A).

According to another, second preferred embodiment, component C) is obtainable from a sol-gel process. It is preferable that component C) here is in the form of gel, or in a form obtained from a gel, when it is brought into contact with component A).

For the purposes of the present invention, a gel is an oxide and/or oxide hydrate of the invention in which the primary particles have been at least partially linked to one another. For the purposes of the present invention, a gel differs from a sol as defined above in being not colloidally dispersible.

Sol-gel processes for the preparation of oxides and/or oxide hydrates of metals and/or semimetals are known to the person skilled in the art. These sol-gel processes are described by way of example in Sanchez et al., Chemistry of Materials 2001, 13, 3061-3083.

A sol-gel process for the preparation of component C) preferably comprises the following steps:
at least one starting compound is provided, together with a solvent and, if appropriate, with further additives;
the starting compound is hydrolyzed, and a polycondensation reaction proceeds here, giving component C) in the form of a gel;
if appropriate, the solvent is removed from component C).

The gels can moreover be prepared starting from the sols described at an earlier stage above, via crosslinking of the colloidal particles. Accordingly, processes for the preparation of the sols sometimes differ from the processes for the preparation of gels only via variation of certain process parameters, e.g. pH.

In one particularly preferred embodiment, the starting compounds used comprise those which comprise the metal and/or semimetal M and at least three alkoxylate groups RO, bonded to M. The starting compound preferably comprises no ligands other than RO. In one preferred embodiment, starting compounds of type M(OR)ₙ are used, where it is particularly preferable that n=2, 3, or 4 and it is very particularly preferable that n=4.

The alkoxylate groups RO can, independently of one another, be identical or different, and in the latter case here the structure M(OR)ᵣ(OR¹)ₜ, is preferred, where r=2 or 3 and t=1 or 2. It is preferable that r+t=4.

R and R¹ are generally linear or branched aliphatic groups which comprise from 1 to 12 carbon atoms. The linear or branched aliphatic groups R and R¹ preferably comprise from 2 to 8 carbon atoms. Suitable groups R and R¹ are linear or branched aliphatic alkyl groups, such as methyl, ethyl, n-propyl, isopropyl, n-butyl, isobutyl, n-pentyl, n-hexyl and n-octyl. Other suitable groups R are aromatic hydrocarbon groups, in particular phenyl. It is preferable that R and R¹ have from 2 to 4 carbon atoms and that they are selected from ethyl, n-propyl, isopropyl, n-butyl, and isobutyl.

In another preferred embodiment, two, or more than two, different starting compounds respectively comprising at least one metal or semimetal M are used, where at least one of the starting compounds comprises an M selected from Si, Ti, Fe, Ba, Zr, Zn, Al, Ga, In, Sb, Bi, Cu, Ge, Hf, La, Li, Nb, Na, Ta, Y, Mo, V, and Sn. The result is mixed oxides and/or oxide hydrates.

It is preferable that at least one of the starting compounds is selected from the metal alkoxylates or semimetal alkoxylates listed above. The second and, if appropriate, further starting compounds are then preferably composed of soluble salts of metals and/or semimetals, examples being acetates or hydroxides, which with the metals and/or semimetals form mixed oxides.

The preferably preferred starting compounds for the sol-gel process are tetraethyl orthosilicate (TEOS), titanium tetraisopropoxide (TPOT), and titanium tetra-n-butoxide. It is moreover preferable to use a mixture composed of TPOT and barium hydroxide as starting compounds.

Catalysts that can be used for the preparation of the gels are preferably acids, preferably strong acids, e.g. hydrochloric acid or sulfuric acid. The pH values preferably used here to carry out the sol-gel process here are below 5, for example from 1 to 4, preferably from 2 to 4.

In another preferred embodiment, the precursors of component C) comprise salts of oxyacids based on the metal and/or semimetal M, or comprise the acids themselves, preferably those whose structure is (MOₓ.nH₂O), where x is preferably 2. A known example of this type of acid is silicic acid. Starting from this precursor, the sol or the gel is obtained in a known manner in the presence of a solvent, preferably water, via hydrolysis, preferably catalyzed by a catalyst. Catalysts that can be used are acids and bases.

Suitable solvents for the processes described are known to the person skilled in the art. In principle, any of the known protic solvents can be used as solvents for the preparation processes described for component C). Examples of suitable solvents are water, alcohols, and mixtures composed of water and alcohols. The preferred solvent is water.

Component C) is porous in the form used, i.e. prior to contact with component A). Porous materials comprise cavities, in particular pores of different shape and size.

Component C) is preferably microporous. Microporous materials are those comprising micropores. For the purposes of the present invention, micropores are pores with diameters of less than 2 nm, as required by IUPAC classification. These microporous materials have large specific surface areas.

To determine microporosity, the person skilled in the art in particular uses the adsorption isotherm of argon (Ar). The region of low argon pressure is analyzed here to determine microporosity.

For the purposes of the present invention, a microporous compound is characterized in that it absorbs an amount of at least 30 cm³ of argon per gram of specimen material (component C in the form used) in volumetric measurement of the adsorption isotherm at standard temperature and standard pressure (STP) at an absolute pressure of 2670 Pa. The adsorption isotherm is recorded here at a temperature of 87.4 K using an equilibrium period of 10 s to DIN 66135-1.

It is preferable that component C) in the form used absorbs at least 60 cm³ of Ar per gram of specimen material in the method described above at an absolute pressure of 2670 Pa and a temperature of 87.4 K to DIN 66135-1. It is particularly preferable that component C) in the form used adsorbs at least 80 cm³ per gram of specimen material, in particular at least 100 cm³/g, in the method described above at an absolute pressure of 2670 Pa and a temperature of 87.4 K to DIN 66135-1.

It is moreover preferable that component C) in the form used adsorbs at least 50 cm³, preferably at least 70 cm³, in particular at least 90 cm³, of Ar per gram of specimen material in the method described above at an absolute pressure of 1330 Pa and at a temperature of 87.4 K to DIN 66135-1.

For structural reasons, suitable oxides and/or oxide hydrates of metals and/or semimetals have an upper limit in relation to the amount of argon adsorbed under the conditions described. This upper limit is by way of example 500 cm³ of Ar per gram of specimen material in the method described above at an absolute pressure of 2670 Pa and at a temperature of 87.4 K to DIN 66135-1 and by way of example 400 cm³ of Ar per gram of specimen material at an absolute pressure of 1330 Pa and at a temperature of 87.4 K.

In order to determine the proportion by volume of the micropores and the specific surface area of the micropores, various methods can be used, starting from the argon adsorption isotherms described.

One suitable method is the DFT (density functional theory) method of Olivier and Conklin, which is described in Olivier, J. P., Conklin, W. B., and v. Szombathely, M.: “Characterization of Porous Solids III” (J. Rouquerol, F. Rodrigues-Reinoso, K. S. W. Sing, and K. K. Unger, Eds.), p. 81 Elsevier, Amsterdam, 1994. This method is referred to hereinafter by the abbreviation Olivier-Conklin DFT method.

It is preferable that component C) in the form used has a cumulative specific surface area of micropores (pores smaller than 2 nm) of at least 40 m²/g, preferably at least 60 m²/g, in particular at least 100 m²/g, for example at least 150 m²/g, determined by means of the Olivier-Conklin DFT method applied to the Ar adsorption isotherm recorded at a temperature of 87.4 K to DIN 66135-1, where the model parameters selected for the mathematical modeling process are: slit-shaped pores, non-negative regularization, no smoothing.

Suitable components C) have an upper limit resulting from their structure in relation to the cumulative specific surface area of micropores, an example of this being about 600 m²/g. It is preferable that component C) in the form used has a cumulative specific surface area of micropores of from 40 to 500 m²/g, in particular from 100 to 400 m²/g, determined in each case by the Olivier-Conklin DFT method.

Component C) in the form used can moreover be characterized by the method of Brunauer, Emmet, and Teller (BET). For the purposes of the present invention, the BET method is analysis of the nitrogen adsorption isotherm at a temperature of 77.35 K to DIN 66131. The BET method is not selective for micropores. The specific surface area thus obtained also characterized pores in the range from 2 to 50 nm (macropores).

It is preferable that component C) in the form used has a BET-method specific surface area of at least 150 m²/g, particularly preferably at least 250 m²/g, in particular at least 350 m²/g. For the purposes of the present invention, suitable components C) have an upper limit for BET specific surface area which results from their structure and is in the region of about 800 m²/g, and which depends inter alia in a known manner on the average particle size selected, and which should not be selected to be excessively large.

It is preferable that component C) has a BET specific surface area to DIN 66131 of from 150 to 700 m²/g, in particular from 200 to 500 m²/g.

The oxides and/or oxide hydrates C) can comprise a single metal and/or semimetal, or can be oxides and/or oxide hydrates of a combination composed of two or more metals and/or semimetals M selected from Si, Ti, Fe, Ba, Zr, Zn, Al, Ga, In, Sb, Bi, Cu, Ge, Hf, La, Li, Nb, Na, Ta, Y, Mo, V, and Sn. The oxides and/or oxide hydrates here comprise oxygen-linked oxidic polymeric networks, which in part can also comprise hydroxy groups as ligands and/or chemically bonded water (oxide hydrates in the latter case). Component C) can moreover comprise contaminants in the form of ions other than M, in particular alkali metals and/or alkaline earth metals, and also non-hydrolyzed or non-hydrolyzable ligands.

In one particularly preferred embodiment, the inventive thermoplastic molding compositions comprise, as component C), an amorphous oxide and/or oxide hydrate of silicon with a number-average diameter of the primary particles of from 0.5 to 20 nm. The SiO₂ can also comprise OH ligands and/or water.

It is preferable that component C) in the form used has a number-average diameter of the primary particles of from 1 to 15 nm, preferably from 1 to 10 nm, in particular from 2 to 8 nm.

It is preferable that the number-average diameter of the primary particles is selected in such a way that it is smaller than the z-average gyration radius R_{g} of component A). In particular, component C) has a number-average diameter of the primary particles of at least 1 nm and smaller than R_{g}, particularly preferably from 1 nm to (R_{g} minus 3 nm).

The z-average gyration radius R_{g} is calculated as follows for the purposes of the present invention:

$${R}_{g} = {( \frac{2 {M}_{n}}{3} )}^{0.5} b ,$$

where b is the segment length of a monomer unit of component A). The person skilled in the art calculates b as atomic separation between the two ends of a monomer unit, by means of molecular-modeling calculations. Mₙ is based on the number-average molecular weight determined by means of gel permeation chromatography (GPC) to ISO 16014-4 at a temperature of 140° C. in sulfuric acid as solvent.

Various determination methods can be used to determine average particle diameters. The average particle diameter of colloidal solutions is known to be in particular capable of determination by means of an ultracentrifuge.

The number-average particle diameter of nanoparticles in a polymer matrix is determined for the purposes of the present invention by means of transmission electron microscopy (TEM) by studying a representative microtome, i.e. one which is statistically significant.

For the purposes of the present invention, the number-average particle diameter is the median value d₅₀ obtained via image-analysis evaluation of a TEM measurement on the thermoplastic molding composition, preferably by evaluation of a microtome of thickness 70 nm or less. The person skilled in the art will select the thickness, size, and number of the sections in such a way as to give a statistically significant average, and in particular the number of the particles of component C) used must amount to at least 100. A factor to be taken into account in the evaluation, if the material comprises further added particulate materials, is that only component C) is used for determining the average.

Another factor to be taken into account in determining the d₅₀ value is that the diameters of the primary particles are used for the determination, rather than the size of agglomerates or of other secondary structures.

Particles whose size is more than 100 nm should be ignored in the evaluation, since they are not considered to be nanoparticulate oxides and/or oxide hydrates for the purposes of the invention. Oxidic pigments can by way of example be present as component F) in the form of pigments in the molding compositions of the invention.

The particle diameter is the smallest diameter through the geometric centre of the particle depicted in the TEM image.

The particles of component C) are preferably substantially isotropic. It is preferable that in component C) the average aspect ratio of the longest to the shortest diameter (length/width) through the geometric centre of the particle is from 4 to 1, in particular from 3 to 1, particularly preferably from 2 to 1. It is particularly preferable that in component C) the average aspect ratio is about 1, in particular from 1 to 1.4. The average aspect ratio is determined by analogy with the average particle diameter by image analysis using TEM, and for the purposes of the present invention is determined and stated in the form of d50 values.

In the process of the present invention, it is moreover preferable that the spatial dispersion of the nanoparticles in the thermoplastic molding composition is substantially homogeneous, i.e. that the particles have substantially uniform spatial dispersion.

It is moreover preferable that there is relatively restricted breadth of distribution of particle diameter. In other words: component C) preferably has a narrow particle size distribution, and in particular the particle diameters are in essence in the range from 1 to 20 nm, particularly preferably from 1 to 10 nm, very particularly preferably from 2 to 8 nm. It is very particularly preferable that the distribution of particle size of component C) is in essence monomodal and narrow, i.e. that the distribution of particle size of component C) is similar to a Poisson distribution.

Component D

The thermoplastic molding compositions of the invention can moreover comprise, as component D), at least one hyperbranched polymer not identical with component B). Examples of hyperbranched polymers that can be used and that are not identical with component B) are polyamidoamines, polyesters, and in particular polyetheramines.

If a polyetheramine is used as component D), one preferred embodiment of the thermoplastic molding compositions of the invention comprises from 0.05 to 30% by weight of at least one polyetheramine. The proportion of component D) is preferably from 0.05 to 4% by weight and in particular from 0.1 to 3% by weight, based on the total of the % by weight values from A) to D).

For the purposes of said embodiment, the thermoplastic molding compositions of the invention particularly preferably comprise from 55 to 99.85% by weight of component A), from 0.05 to 15% by weight of component B), from 0.05 to 15% by weight of component C), and from 0.05 to 15% by weight of component D), where the total of the percentages by weight of components A) to D) is 100% by weight.

Component D) is preferably obtainable via reaction of
at least one tertiary amine having functional hydroxy groups, in particular at least one di-, tri-, or tetraalkanolamine, optionally in the presence of
secondary amines which bear hydroxy groups as substituent, in particular dialkanolamines, and/or optionally in the presence of
polyether polyols whose functionality is two or higher,

where the reaction is preferably carried out in the presence of a transesterification and etherification catalyst.

Preferred tertiary dialkanolamines having functional hydroxy groups are:

Diethanolalkylamines having C1to C30, in particular C1 to C18-alkyl radicals, diethanolamine, dipropanolamine, diisopropanolamine, dibutanolamine, dipentanolamine, dihexanolamine, N-methyldiethanolamine, N-methyldipropanolamine, N-methyldiisopropanolamine, N-methyldibutanolamine, N-methyldipentanolamine, N-methyldihexanolamine, N-ethyldiethanolamine, N-ethyldipropanolamine, N-ethyldiisopropanolamine, N-ethyldibutanolamine, N-ethyldipentanolamine, N-ethyldihexanolamine, N-propyldiethanolamine, N-propyldipropanolamine, N-propyldiisopropanolamine, N-propyldibutanolamine, N-propyldipentanolamine, N-propyldihexanolamine, diethanolethylamine, diethanolpropylamine, diethanolmethylamine, dipropanolmethylamine, cyclohexanoldiethanolamine, dicyclohexanolethanolamine, cyclohexyldiethanolamine, dicyclohexyldiethanolamine, dicyclohexanolethylamine, benzyldiethanolamine, dibenzylethanolamine, benzyldipropanolamine, tripentanolamine, trihexanolamine, ethylhexylethanolamine, octadecyldiethanolamine, and polyethanolamines.

Preferred trialkanolamines are trimethanolamine, triethanolamine, tripropanolamine, triisopropanolamine, tributanolamine, tripentanolamine, and the derivatives derived therefrom.

Other preferred trialkanolamines are:

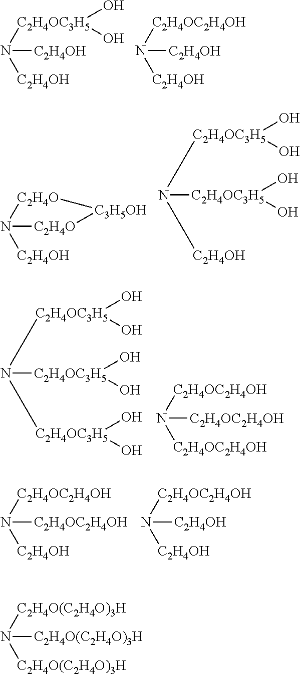

Preferred tetraalkanolamines are:

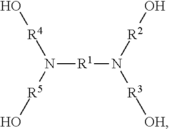

where it is preferable that R¹═CH₂—CH₂ to (CH₂)₈, in particular (CH₂)₂—(CH₂)₄; and where R²-R⁵ are preferably C₂ to C₆, in particular C₂ and C₃, particular preference being given here to N,N,N′,N′-tetrahydroxyethylethylenediamine, N,N,N′,N′-tetrahydroxy-ethylbutylenediamine, N,N,N′,N′-tetrahydroxypropylethylenediamine, N,N,N′,N′-tetra-hydroxyisopropylethylenediamine, N,N,N′,N′-tetrahydroxypropylbutylenediamine, N,N,N′,N′-tetrahydroxyisopropylbutylenediamine.

It is preferable that component D) has an average of at least 3 functional OH groups per molecule, i.e. that average OH functionality is at least 3.

It is particularly preferable that component D) is obtainable via reaction of at least one trialkanolamine optionally with dialkanolamines and/or optionally with polyetherols whose functionality is two or higher.

In one particularly preferred embodiment, component D) is obtainable via reaction of at least one trialkanolamine of the general formula

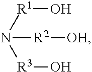

in which the radicals R¹ to R³, independently of one another, are identical or different linear or branched alkylene groups, preferably having from 2 to 10 carbon atoms, in particular from 2 to 6 carbon atoms.

The starting material used preferably comprises triethanolamine, tripropanolamine, triisopropanolamine, or tributanolamine, or a mixture of these; if appropriate in combination with dialkanolamines, such as diethanolamine, dipropanolamine, diisopropanolamine, dibutanolamine, N,N′-dihydroxyalkylpiperidine (alkyl=C1-C8), dicyclohexanolamine, dipentanolamine, or dihexanolamine, preference being given to dialkanolamines here.

The abovementioned trialkanolamines can, if appropriate, moreover be used in combination with polyetherols Of functionality two or higher, in particular those based on ethylene oxide and/or propylene oxide.

However, it is very particularly preferable that the starting material used comprises triethanolamine or triisopropanolamine, or a mixture of these.

The hyperbranched polyetheramines D) have termination by hydroxy groups after the reaction, i.e. without further modification. They have good solubility in various solvents.

Examples of these solvents are aromatic and/or (cyclo)aliphatic hydrocarbons and mixtures of these, halogenated hydrocarbons, ketones, esters, and ethers.

Preference is given to aromatic hydrocarbons, (cyclo)aliphatic hydrocarbons, alkyl alkanoates, ketones, alkoxylated alkyl alkanoates, and mixtures of these.

Particular preference is given to mono- or polyalkylated benzenes and naphthalenes, ketones, alkyl alkanoates, and alkoxylated alkyl alkanoates, and also mixtures of these.

Preferred aromatic hydrocarbon mixtures are those which mainly comprise aromatic C₇-C₁₄ hydrocarbons and whose boiling range is from 110 to 300° C., particular preference being given to toluene, o-, m- or p-xylene, trimethylbenzene isomers, tetramethylbenzene isomers, ethylbenzene, cumene, tetrahydronaphthalene, and mixtures comprising these.

Examples of these compounds are the products with trademark Solvesso® from ExxonMobil Chemical, particularly Solvesso® 100 (CAS No. 64742-95-6, mainly C₉ and C₁₀ aromatic compounds, boiling range about 154-178° C.), 150 (boiling range about 182-207° C.) and 200 (CAS No. 64742-94-5), and also the products with trademark Shellsol® from Shell. Hydrocarbon mixtures based on paraffins, on cycloparaffins, and on aromatic compounds are also available commercially as gasoline (for example Kristallöl 30, boiling range about 158-198° C. or Kristallöl 60: CAS No. 64742-82-1), white spirit (an example likewise being CAS No. 64747-82-1), or solvent naphtha (light: boiling range about 155-180° C., heavy: boiling range about 225-300°). The content of aromatic compounds of these hydrocarbon mixtures is generally more than 90% by weight, preferably more than 95% by weight, particularly preferably more than 98% by weight, and very particularly preferably more than 99% by weight. It can be advisable to use hydrocarbon mixtures with particularly reduced content of naphthalene.

The content of aliphatic hydrocarbons is generally less than 5% by weight, preferably less than 2.5% by weight, and particularly preferably less than 1% by weight.

Examples of halogenated hydrocarbons are chlorobenzene and dichlorobenzene, or its isomer mixtures.

Examples of esters are n-butyl acetate, ethyl acetate, 1-methoxyprop-2-yl acetate, and 2-methoxyethyl acetate.

Examples of ethers are THF, dioxane, and also the dimethyl, ethyl, or n-butyl ether of ethylene glycol, diethylene glycol, triethylene glycol, propylene glycol, dipropylene glycol, or tripropylene glycol.

Examples of ketones are acetone, 2-butanone, 2-pentanone, 3-pentanone, hexanone, isobutyl methyl ketone, heptanone, cyclopentanone, cyclohexanone, or cycloheptanone.

Examples of (cyclo)aliphatic hydrocarbons are decalin, alkylated decalin, and isomer mixtures of straight-chain or branched alkanes and/or of cycloalkynes.

Preference is further given to n-butyl acetate, ethyl acetate, 1-methoxy-2-propyl acetate, 2-methoxyethyl acetate, 2-butanone, isobutyl methyl ketone, and also mixtures of these, in particular with the aromatic hydrocarbon mixtures listed above.

These mixtures can be produced in a ratio by volume of from 5:1 to 1:5, preferably in a ratio by volume of from 4:1 to 1:4, particularly preferably in a ratio by volume of 3:1 to 1:3, and very particularly preferably in a ratio by volume of 2:1 to 1:2.

Preferred solvents are butyl acetate, methoxypropyl acetate, isobutyl methyl ketone, 2-butanone, Solvesso® grades, and xylene.

Examples of other solvents that can be suitable for the polyetheramines are water, alcohols, such as methanol, ethanol, butanol, alcohol/water mixtures, acetone, 2-butanone, dimethylformamide, dimethylacetamide, N-methylpyrrolidone, N-ethylpyrrolidone, ethylene carbonate, or propylene carbonate.

The polyetheramines are prepared either in bulk or in solution. Solvents that can be used are the solvents mentioned above. Conduct of the reaction without solvent is a preferred embodiment.

The temperature during the preparation process should be sufficient for reaction of the amino alcohol. The temperature needed for the reaction is generally from 100° C. to 350° C., preferably from 150 to 300° C., particularly preferably from 180 to 280° C., and specifically from 200 to 250° C.

In one preferred embodiment, the condensation reaction is carried out in bulk. The water liberated during the reaction, or low-molecular-weight reaction products, can be removed from the reaction equilibrium, for example by distillation, if appropriate at reduced pressure, in order to accelerate the reaction.

The removal of the water or of the low-molecular-weight reaction products can also be promoted by passage of a gas stream which is substantially inert under the reaction conditions, e.g. nitrogen or noble gas, e.g. helium, neon, or argon, through the mixture (stripping).

Catalysts or catalyst mixtures can preferably be added to accelerate the reaction. Suitable catalysts are compounds which catalyze etherification or transetherification reactions, examples being alkali metal hydroxides, alkali metal carbonates, and alkali metal hydrogencarbonates, preferably of sodium, of potassium, or of cesium, acidic compounds such as iron chloride or zinc chloride, formic acid, oxalic acid, or phosphorus-comprising acidic compounds, such as phosphoric acid, polyphosphoric acid, phosphorous acid, or hypophosphorous acid.

It is preferable to use phosphoric acid, phosphorous acid, or hypophosphorous acid, if appropriate in a form diluted with water.

The amount generally added of the catalyst is from 0.001 to 10 mol %, preferably from 0.005 to 7 mol %, particularly preferably from 0.01 to 5 mol %, based on the amount of the alkanolamine or alkanolamine mixture used.

It is moreover possible to control the intermolecular polycondensation reaction either via addition of the suitable catalyst or via selection of a suitable temperature. The constitution of the starting components and the residence time can moreover be used to adjust the average molecular weight of the polymer.

The polymers prepared at an elevated temperature are usually stable for a prolonged period, for example for at least 6 weeks, at room temperature without clouding, sedimentation, and/or any rise in viscosity.

There are various methods of terminating the intermolecular polycondensation reaction. By way of example, the temperature can be lowered to a range in which the reaction stops, and the polycondensation product is storage-stable. This is generally the case at below 60° C., preferably below 50° C., particularly preferably below 40° C., and very particularly preferably room temperature.

The catalyst may moreover be deactivated, by way of example in the case of basic catalysts via addition of an acidic component, e.g. of a Lewis acid or of an organic or inorganic protic acid, and in the case of acidic catalysts via addition of a basic component, e.g. of a Lewis base or of an organic or inorganic base.

It is moreover possible to stop the reaction via dilution with a precooled solvent. This is preferred particularly when the viscosity of the reaction mixture has to be adjusted via addition of solvent.

Component E

In one preferred embodiment, the thermoplastic molding compositions of the invention moreover comprise, as component E), at least one fibrous filler not identical with components A) to D), preferably fibrous fillers, in particular glass fibers.

Component E) preferably has a number-average particle diameter of from 0.01 to 100 μm, in particular from 0.5 to 50 μm. Component E) moreover preferably has an aspect ratio of from 5 to 10 000, in particular from 10 to 5000.

In one particularly preferred embodiment, the thermoplastic molding compositions comprise from 15 to 98.8% by weight of component A), from 0.1 to 10% by weight of component B), from 0.1 to 10% by weight of component C), from 0 to 5% by weight of component D), and from 1 to 70% by weight of component E), where the total of the percentages by weight of components A) to E) is 100% by weight.

The following compounds may be mentioned as fibers or particulate fillers E) with a number-average particle diameter of from 0.1 to 50 μm: carbon fibers, glass fibers, glass beads, amorphous silica, calcium silicate, calcium metasilicate, magnesium carbonate, kaolin, chalk, powdered quartz, mica, barium sulfate, and feldspar. The amounts preferably used in the compounds mentioned are up to 40% by weight, in particular from 1 to 15% by weight.

Preferred fibrous fillers that may be mentioned are glass fibers, carbon fibers, carbon nanofibers, carbon nanotubes, aramid fibers, and potassium titanate fibers, particular preference being given to glass fibers, in particular glass fibers in the form of E glass. These can be used in the form of rovings or chopped glass, in the forms commercially available. The fibrous fillers E) mentioned can be used individually, but the molding compositions of the invention can also comprise two or more fibrous fillers E).

The fibrous fillers may have been surface-pretreated with a silane compound to improve compatibility with the thermoplastic.

Suitable silane compounds are those of the general formula

(X—(CH₂)ₙ)ₖ—Si—(O—CₘH₂ₘ₊₁)₄₋ₖ

where the substituents are:

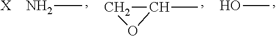

n is a whole number from 2 to 10, preferably from 3 to 4

m is a whole number from 1 to 5, preferably from 1 to 2

k is a whole number from 1 to 3, preferably 1.

Preferred silane compounds are aminopropyltrimethoxysilane, aminobutyltrimethoxysilane, aminopropyltriethoxysilane, aminobutyltriethoxysilane, and also the corresponding silanes which comprise a glycidyl group as substituent X.

The amounts generally used of the silane compounds for surface coating are from 0.01 to 2% by weight, preferably from 0.025 to 1.0% by weight, and in particular from 0.05 to 0.5% by weight (based on the fibrous fillers).

It is preferable to use mineral fillers as component E), in particular fibrous mineral fillers. Mineral fillers are non-amorphous, i.e. in essence crystalline, fillers which in particular are obtained from natural starting materials.

For the purposes of the invention, acicular mineral fillers are mineral fillers with very pronounced acicular character. An example which may be mentioned is acicular wollastonite. The L/D (length/diameter) ratio of the mineral is preferably from 8:1 to 35:1, with preference from 8:1 to 11:1. If appropriate, the mineral filler may have been pretreated with the abovementioned silane compounds; however, this pretreatment is not essential.

Further mineral fillers that may be mentioned are kaolin, calcined kaolin, wollastonite, talc, and chalk, and also the lamellar or fibrous phyllosilicates which are usually used as fillers. The preferred amounts used of these are from 0.1 to 10%, and in the case of the phyllosilicates they can, if appropriate, have a particle diameter in the range below 500 nm, for example from 20 to 100 nm, in one or two spatial dimensions.

Preference is given to use of boehmite, bentonite, montmorillonite, vermiculite, hectorite, and laponite for this purpose. In order to obtain good compatibility of the lamellar nanofillers with the organic binder, organic modification is provided of the lamellar nanofillers according to the prior art. Addition of the lamellar or acicular nanofillers to the inventive nanocomposites brings about a further increase in mechanical strength.

In particular, talc is used, this being a hydrated magnesium silicate whose constitution is Mg₃[(OH)₂/Si₄O₁₀] or 3MgO.4SiO₂.H₂O. These “three-layer phyllosilicates” have a triclinic, monoclinic, or rhombic crystal structure, with lamellar habit. Other trace elements which may be present are Mn, Ti, Cr, Ni, Na, and K, and the OH group may to some extent have been replaced by fluoride.

It is particularly preferable to use talc comprising 99.5% of particles whose sizes are <20 μm. The particle size distribution is usually determined via sedimentation analysis, and is preferably:

<20 μm 99.5% by weight

<10 μm 99% by weight

<5 μm 85% by weight

<3 μm 60% by weight

<2 μm 43% by weight.

Products of this type are commercially available as Micro-Talc I.T. extra (Omya).

Component F

The thermoplastic molding compositions of the invention can moreover comprise further added materials as component F).

The molding compositions of the invention can comprise, as component F), from 0 to 70% by weight, in particular up to 50% by weight, of further added materials and processing aids, where these differ from A) to E).

The molding compositions of the invention can comprise, as component F), from 0 to 3% by weight, preferably from 0.05 to 3% by weight, with preference from 0.1 to 1.5% by weight, and in particular from 0.1 to 1% by weight, of a lubricant.

Preference is given to the Al, alkali metal, or alkaline earth metal salts, or esters or amides of fatty acids having from 10 to 44 carbon atoms, preferably having from 14 to 44 carbon atoms. The metal ions are preferably alkaline earth metal and Al, particular preference being given to Ca or Mg. Preferred metal salts are Ca stearate and Ca montanate, and also Al stearate. It is also possible to use a mixture of various salts, in any desired mixing ratio.

The carboxylic acids can be monobasic or dibasic. Examples which may be mentioned are pelargonic acid, palmitic acid, lauric acid, margaric acid, dodecanedioic acid, behenic acid, and particularly preferably stearic acid, capric acid, and also montanic acid (a mixture of fatty acids having from 30 to 40 carbon atoms).

The aliphatic alcohols can be monohydric to tetrahydric. Examples of alcohols are n-butanol, n-octanol, stearyl alcohol, ethylene glycol, propylene glycol, neopentyl glycol, pentaerythritol, preference being given to glycerol and pentaerythritol.

The aliphatic amines can be mono- to tribasic. Examples of these are stearylamine, ethylenediamine, propylenediamine, hexamethylenediamine, di(6-aminohexyl)amine, particular preference being given to ethylenediamine and hexamethylenediamine. Preferred esters or amides are correspondingly glycerol distearate, glycerol tristearate, ethylenediamine distearate, glycerol monopalmitate, glycerol trilaurate, glycerol monobehenate, and pentaerythritol tetrastearate.

It is also possible to use a mixture of various esters or amides, or of esters with amides in combination, in any desired mixing ratio.

The inventive molding compositions can comprise, as other components F), heat stabilizers or antioxidants, or a mixture of these, selected from the group of the copper compounds, sterically hindered phenols, sterically hindered aliphatic amines, and/or aromatic amines.

The inventive molding compositions comprise from 0.05 to 3% by weight, preferably from 0.1 to 1.5% by weight, and in particular from 0.1 to 1% by weight, of copper compounds, preferably in the form of Cu(I) halide, in particular in a mixture with an alkali metal halide, preferably Kl, in particular in the ratio 1:4, or of a sterically hindered phenol or of an amine stabilizer, or a mixture of these.

Preferred salts of monovalent copper used are cuprous acetate, cuprous chloride, cuprous bromide, and cuprous iodide. The materials comprise these in amounts of from 5 to 500 ppm of copper, preferably from 10 to 250 ppm, based on polyamide.

The advantageous properties are in particular obtained if the copper is present with molecular distribution in the polyamide. This is achieved if a concentrate comprising polyamide, and comprising a salt of monovalent copper, and comprising an alkali metal halide in the form of a solid, homogeneous solution is added to the molding composition. By way of example, a typical concentrate is composed of from 79 to 95% by weight of polyamide and from 21 to 5% by weight of a mixture composed of copper iodide or copper bromide and potassium iodide. The copper concentration in the solid homogenous solution is preferably from 0.3 to 3% by weight, in particular from 0.5 to 2% by weight, based on the total weight of the solution, and the molar ratio of cuprous iodide to potassium iodide is from 1 to 11.5, preferably from 1 to 5.

Suitable polyamides for the concentrate are homopolyamides and copolyamides, in particular nylon-6 and nylon-6,6.

Suitable sterically hindered phenols are in principle any of the compounds having a phenolic structure and having at least one bulky group on the phenolic ring.

By way of example, compounds of the formula

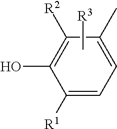

can preferably be used, in which:

R¹ and R² are an alkyl group, a substituted alkyl group, or a substituted triazole group, where the radicals R¹ and R² can be identical or different, and R³ is an alkyl group, a substituted alkyl group, an alkoxy group, or a substituted amino group.

Antioxidants of the type mentioned are described by way of example in DE-A 27 02 661 (U.S. Pat. No. 4,360,617).

Another group of preferred sterically hindered phenols is that derived from substituted benzenecarboxylic acids, in particular from substituted benzenepropionic acids.

Particularly preferred compounds from this class are compounds of the formula

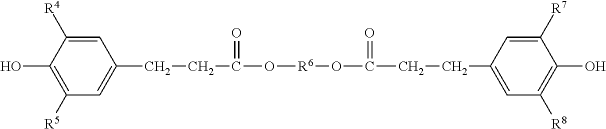

where R⁴, R⁵, R⁷, and R⁸, independently of one another, are C₁-C₈-alkyl groups which themselves may have substitution (at least one of these being a bulky group), and R⁶ is a divalent aliphatic radical which has from 1 to 10 carbon atoms and whose main chain may also have C—O bonds.

Preferred compounds corresponding to these formulae are

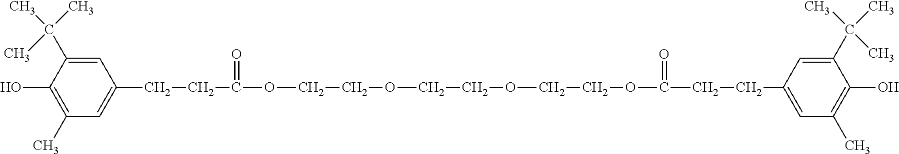

(Irganox® 245 from Ciba-Geigy)

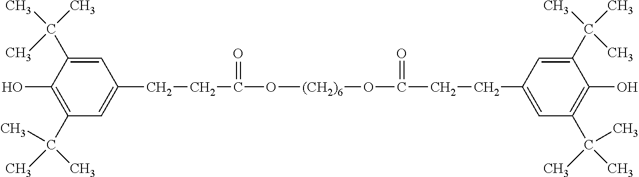

(Irganox® 259 from Ciba-Geigy)

All of the following should be mentioned as examples of sterically hindered phenols:

2,2′-methylenebis(4-methyl-6-tert-butylphenol), 1,6-hexanediol bis[3-(3,5-di-tert-butyl-4-hydroxyphenyl)propionate], pentaerythrityl tetrakis[3-(3,5-di-tert-butyl-4-hydroxy-phenyl)propionate], distearyl 3,5-di-tert-butyl-4-hydroxybenzylphosphonate, 2,6,7-trioxa-1-phosphabicyclo[2.2.2]oct-4-ylmethyl 3,5-di-tert-butyl-4-hydroxyhydro-cinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxy-benzyl)benzene, 4,4′-methylenebis(2,6-di-tert-butylphenol), 3,5-di-tert-butyl-4-hydroxy-benzyldimethylamine.

Compounds which have proven particularly effective and which are therefore used with preference are 2,2′-methylenebis(4-methyl-6-tert-butylphenol), 1,6-hexanediol bis(3,5-di-tert-butyl-4-hydroxyphenyl]propionate (Irganox® 259), pentaerythrityl tetrakis[3-(3,5-di-tert-butyl-4-hydroxyphenyl)propionate], and also N,N′-hexamethylene-bis-3,5-di-tert-butyl-4-hydroxyhydrocinnamide (Irganox® 1098), and the product Irganox® 245 described above from Ciba Geigy, which has particularly good suitability.

The material comprises amounts of from 0.05 to 3% by weight, preferably from 0.1 to 1.5% by weight, in particular from 0.1 to 1% by weight, based on the total weight of the molding compositions A) to F), of the phenolic antioxidants, which may be used individually or in the form of a mixture.

In some instances, sterically hindered phenols having not more than one sterically hindered group in ortho-position with respect to the phenolic hydroxy group have proven particularly advantageous, in particular when assessing colorfastness on storage in diffuse light over prolonged periods.

Examples of impact modifiers as component F) are rubbers which can have functional groups. It is also possible to use a mixture composed of two or more different impact-modifying rubbers.

Rubbers which increase the toughness of the molding compositions generally comprise elastomeric content whose glass transition temperature is below −10° C., preferably below −30° C., and comprise at least one functional group capable of reaction with the polyamide. Examples of suitable functional groups are carboxylic acid, carboxylic anhydride, carboxylic ester, carboxamide, carboximide, amino, hydroxy, epoxy, urethane, or oxazoline groups, preferably carboxylic anhydride groups.

Among the preferred functionalized rubbers are functionalized polyolefin rubbers whose structure is composed of the following components:
1. from 40 to 99% by weight of at least one alpha-olefin having from 2 to 8 carbon atoms,
2. from 0 to 50% by weight of a diene,
3. from 0 to 45% by weight of a C₁-C₁₂-alkyl ester of acrylic acid or methacrylic acid, or a mixture of such esters,
4. from 0 to 40% by weight of an ethylenically unsaturated C₂-C₂₀ mono- or dicarboxylic acid or of a functional derivative of such an acid,
5. from 0 to 40% by weight of a monomer comprising epoxy groups, and
6. from 0 to 5% by weight of other monomers capable of free-radical polymerization,

where the entirety of components 3) to 5) is at least from 1 to 45% by weight, based on components 1) to 6).

Examples that may be mentioned of suitable alpha-olefins are ethylene, propylene, 1-butylene, 1-pentylene, 1-hexylene, 1-heptylene, 1-octylene, 2-methylpropylene, 3-methyl-1-butylene, and 3-ethyl-1-butylene, preferably ethylene and propylene.

Examples that may be mentioned of suitable diene monomers are conjugated dienes having from 4 to 8 carbon atoms, such as isoprene and butadiene, non-conjugated dienes having from 5 to 25 carbon atoms, such as penta-1,4-diene, hexa-1,4-diene, hexa-1,5-diene, 2,5-dimethylhexa-1,5-diene, and octa-1,4-diene, cyclic dienes, such as cyclopentadiene, cyclohexadienes, cyclooctadienes, and dicyclopentadiene, and also alkenylnorbornene, such as 5-ethylidene-2-norbornene, 5-butylidene-2-norbornene, 2-methallyl-5-norbornene, 2-isopropenyl-5-norbornene, and tricyclodienes, such as 3-methyltricyclo[5.2.1.0^{2,6}]-3,8-decadiene, or a mixture of these. Preference is given to hexa-1,5-diene, 5-ethylidenenorbornene, and dicyclopentadiene.

The diene content is preferably from 0.5 to 50% by weight, in particular from 2 to 20% by weight, and particularly preferably from 3 to 15% by weight, based on the total weight of the olefin polymer. Examples of suitable esters are methyl, ethyl, propyl, n-butyl, isobutyl, and 2-ethylhexyl, octyl, and decyl acrylates and the corresponding methacrylates. Among these, particular preference is given to methyl, ethyl, propyl, n-butyl, and 2-ethylhexyl acrylate and the corresponding methacrylate.

Instead of the esters, or in addition to these, acid-functional and/or latent acid-functional monomers of ethylenically unsaturated mono- or dicarboxylic acids can also be present in the olefin polymers.

Examples of ethylenically unsaturated mono- or dicarboxylic acids are acrylic acid, methacrylic acid, tertiary alkyl esters of these acids, in particular tert-butyl acrylate, and dicarboxylic acids, e.g. maleic acid and fumaric acid, or derivatives of these acids, or else their monoesters.

Latent acid-functional monomers are compounds which, under the polymerization conditions or during incorporation of the olefin polymers into the molding compositions, form free acid groups. Examples that may be mentioned of these are anhydrides of dicarboxylic acids having from 2 to 20 carbon atoms, in particular maleic anhydride and tertiary C₁-C₁₂-alkyl esters of the abovementioned acids, in particular tert-butyl acrylate and tert-butyl methacrylate.

Examples of other monomers that can be used are vinyl esters and vinyl ethers.

Particular preference is given to olefin polymers composed of from 50 to 98.9% by weight, in particular from 60 to 94.85% by weight, of ethylene and from 1 to 50% by weight, in particular from 5 to 40% by weight, of an ester of acrylic or methacrylic acid, from 0.1 to 20.0% by weight, and in particular from 0.15 to 15% by weight, of glycidyl acrylate and/or glycidyl methacrylate, acrylic acid, and/or maleic anhydride.

Particularly suitable functionalized rubbers are ethylene-methyl methacrylate-glycidyl methacrylate polymers, ethylene-methyl acrylate-glycidyl methacrylate polymers, ethylene-methyl acrylate-glycidyl acrylate polymers, and ethylene-methyl methacrylate-glycidyl acrylate polymers.

The polymers described above can be prepared by processes known per se, preferably via random copolymerization at high pressure and elevated temperature.

The melt index of these copolymers is generally in the range from 1 to 80 g/10 min (measured at 190° C. with a load of 2.16 kg).

Other rubbers that may be used are commercial ethylene-α-olefin copolymers which comprise groups reactive with polyamide. The underlying ethylene-α-olefin copolymers are prepared via transition-metal catalysis in the gas phase or in solution. The following α-olefins can be used as comonomers: propylene, 1-butene, 1-pentene, 4-methyl-1-pentene, 1-hexene, 1-heptene, 1-octene, 1-nonene, 1-decene, 1-undecene, 1-dodecene, styrene and substituted styrenes, vinyl esters, vinyl acetates, acrylic esters, methacrylic esters, glycidyl acrylates, glycidyl methacrylates, hydroxyethyl acrylates, acrylamides, acrylonitrile, allylamine; dienes, e.g. butadiene, isoprene.

Ethylene/1-octene copolymers, ethylene/1-butene copolymers, ethylene-propylene copolymers are particularly preferred, and compositions composed of
from 25 to 85% by weight, preferably from 35 to 80% by weight, of ethylene,
from 14.9 to 72% by weight, preferably from 19.8 to 63% by weight, of 1-octene or 1-butene, or propylene, or a mixture of these,
from 0.1 to 3% by weight, preferably from 0.2 to 2% by weight, of an ethylenically unsaturated mono- or dicarboxylic acid, or of a functional derivative of such an acid,

are particularly preferred.

The molar mass of these ethylene-α-olefin copolymers is from 10 000 to 500 000 g/mol, preferably from 15 000 to 400 000 g/mol (Mn, determined by means of GPC in 1,2,4-trichlorobenzene using PS calibration).

The proportion of ethylene in the ethylene-α-olefin copolymers is from 5 to 97% by weight, preferably from 10 to 95% by weight, in particular from 15 to 93% by weight.

One particular embodiment prepared ethylene-α-olefin copolymers by using what are known as “single site catalysts”. Further details can be found in U.S. Pat. No. 5,272,236. In this case, the polydispersity of the ethylene-α-olefin copolymers is narrow for polyolefins: smaller than 4, preferably smaller than 3.5.

Another group of suitable rubbers that may be mentioned is provided by core-shell graft rubbers. These are graft rubbers which are prepared in emulsion and which are composed of at least one hard constituent and of at least one soft constituent. A hard constituent is usually a polymer whose glass transition temperature is at least 25° C., and a soft constituent is usually a polymer whose glass transition temperature is at most 0° C. These products have a structure composed of a core and of at least one shell, and the structure here results via the sequence of addition of the monomers. The soft constituents generally derive from butadiene, isoprene, alkyl acrylates, alkyl methacrylates, or siloxanes, and, if appropriate, from further comonomers. Suitable siloxane cores can, for example, be prepared starting from cyclic oligomeric octamethyltetrasiloxane or tetravinyltetramethyltetrasiloxane. By way of example, these can be reacted with gamma-mercaptopropylmethyldimethoxysilane in a ring-opening cationic polymerization reaction, preferably in the presence of sulfonic acids, to give the soft siloxane cores. The siloxanes can also be crosslinked, for example by carrying out the polymerization reaction in the presence of silanes having hydrolyzable groups, such as halogen or alkoxy groups, e.g. tetraethoxysilane, methyltrimethoxysilane, or phenyltrimethoxysilane. Suitable comonomers that may be mentioned here are, for example, styrene, acrylonitrile, and crosslinking or graft-active monomers having more than one polymerizable double bond, e.g. diallyl phthalate, divinylbenzene, butanediol diacrylate, or triallyl(iso)cyanurate. The hard constituents generally derive from styrene, and from alpha-methylstyrene, and from their copolymers, and preferred comonomers that may be listed here are acrylonitrile, methacrylonitrile, and methyl methacrylate.

Preferred core-shell graft rubbers comprise a soft core and a hard shell, or a hard core, a first soft shell, and at least one further hard shell. Functional groups, such as carbonyl, carboxylic acid, anhydride, amide, imide, carboxylic ester, amino, hydroxy, epoxy, oxazoline, urethane, urea, lactam, or halobenzyl groups, are preferably incorporated here via addition of suitably functionalized monomers during polymerization of the final shell. Examples of suitable functionalized monomers are maleic acid, maleic anhydride, mono- or diesters or maleic acid, tert-butyl(meth)acrylate, acrylic acid, glycidyl(meth)acrylate, and vinyloxazoline. The proportion of monomers having functional groups is generally from 0.1 to 25% by weight, preferably from 0.25 to 15% by weight, based on the total weight of the core-shell graft rubber. The ratio by weight of soft to hard constituents is generally from 1:9 to 9:1, preferably from 3:7 to 8:2.

Such rubbers are known per se and are described by way of example in EP-A-0 208 187. Oxazine groups for functionalization can be incorporated by way of example according to EP-A-0 791 606.

Another group of suitable impact modifiers is provided by thermoplastic polyester elastomers. Polyester elastomers here are segmented copolyetheresters which comprise long-chain segments which generally derive from poly(alkylene) ether glycols and comprise short-chain segments which derive from low-molecular-weight diols and from dicarboxylic acids. Such products are known per se and are described in the literature, e.g. in U.S. Pat. No. 3,651,014. Appropriate products are also commercially available as Hytrel™ (Du Pont), Arnitel™ (Akzo), and Pelprene™ (Toyobo Co. Ltd.).

It is, of course, also possible to use a mixture of the types of rubber listed above.

The thermoplastic molding compositions of the invention can comprise, as further component F), conventional processing aids, such as stabilizers, oxidation retarders, further agents to counter decomposition by heat and decomposition by ultraviolet light, lubricants and mold-release agents, colorants, such as dyes and pigments, nucleating agents, plasticizers, flame retardants, etc.

Examples that may be mentioned of oxidation retarders and heat stabilizers are phosphites and further amines (e.g. TAD), hydroquinones, various substituted representatives of these groups, and their mixtures, at concentrations of up to 1% by weight, based on the weight of the thermoplastic molding composition.

UV stabilizers that may be mentioned, the amounts of which generally used are up to 2% by weight, based on the molding composition, are various substituted resorcinols, salicylates, benzotriazoles, and benzophenones.

Colorants that may be added are inorganic pigments, such as titanium dioxide, ultramarine blue, iron oxide, and carbon black and/or graphite, and also organic pigments, such as phthalocyanines, quinacridones, perylenes, and also dyes, such as nigrosin and anthraquinones.

Nucleating agents that can be used are sodium phenylphosphinate, aluminum oxide, silicon dioxide, and also preferably talc.

Flame retardants that may be mentioned are red phosphorus, P- and N-containing flame retardants, and also halogenated flame retardant systems and their synergists.

Preferred stabilizers are amounts of up to 2% by weight, preferably from 0.5 to 1.5% by weight, and in particular from 0.7 to 1% by weight, of aromatic secondary amine of the general formula I:

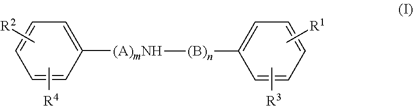

where
m and n=0 or 1
A and B=C₁-C₄-alkyl- or phenyl-substituted tertiary carbon atom,
R¹ and R²=hydrogen or a C₁-C₆-alkyl group in ortho- or para-position, which may, if appropriate, have substitution by from 1 to 3 phenyl radicals, halogen, a carboxy group, or a transition metal salt of said carboxy group, and
R³ and R⁴=hydrogen or a methyl radical in ortho- or para-position, if m plus n is 1, or a tertiary. C₃-C₉-alkyl group in ortho- or para-position, which can, if appropriate, have substitution by from 1 to 3 phenyl radicals, if m plus n is 0 or 1.

Preferred radicals A or B are symmetrically substituted tertiary carbon atoms, particular preference being given to dimethyl-substituted tertiary carbon. Tertiary carbon atoms which have from 1 to 3 phenyl groups as substituents are equally preferred.

Preferred radicals R¹ or R² are para-t-butyl or tetramethyl-substituted n-butyl, where the methyl groups can preferably have been replaced by from 1 to 3 phenyl groups. Preferred halogens are chlorine and bromine. Examples of transition metals are those which can form transition metal salts with R¹ or R²=carboxy.

Preferred radicals R³ or R⁴, for m plus n=2, are hydrogen, and for m plus n=0 or 1, a tert-butyl radical in ortho- or para-position, which in particular can have substitution by from 1 to 3 phenyl radicals.

Examples of secondary aromatic amines F) are

4,4′-bis(α,α′-tert-octyl)diphenylamine

4,4′-bis(α,α-dimethylbenzyl)diphenylamine

4,4′-bis(α-methylbenzhydryl)diphenylamine

4-(1,1,3,3-tetramethylbutyl)-4′-triphenylmethyldiphenylamine

4,4′-bis(α,α-p-trimethylbenzyl)diphenylamine

2,4,4′-tris(α,α-dimethylbenzyl)diphenylamine

2,2′-dibromo-4,4′-bis(α,α-dimethylbenzyl)diphenylamine

4,4′-bis(α,α-dimethylbenzyl)-2-carboxydiphenylamine-nickel-4,4′-bis(α,α-dimethyl-benzyl)diphenylamine

2-sec-butyl-4,4′-bis(α,α-dimethylbenzyl)diphenylamine

4,4′-bis(α,α-dimethylbenzyl)-2-(α-methylheptyl)diphenylamine

2-(α-methylpentyl)-4,4′-ditrityldiphenylamine

4-α,α-dimethylbenzyl-4′-isopropoxydiphenylamine

2-(α-methylheptyl)-4′-(α,α-dimethylbenzyl)diphenylamine

2-(α-methylpentyl)-4′-trityldiphenylamine, and also

4,4′-bis(tert-butyl)diphenylamine

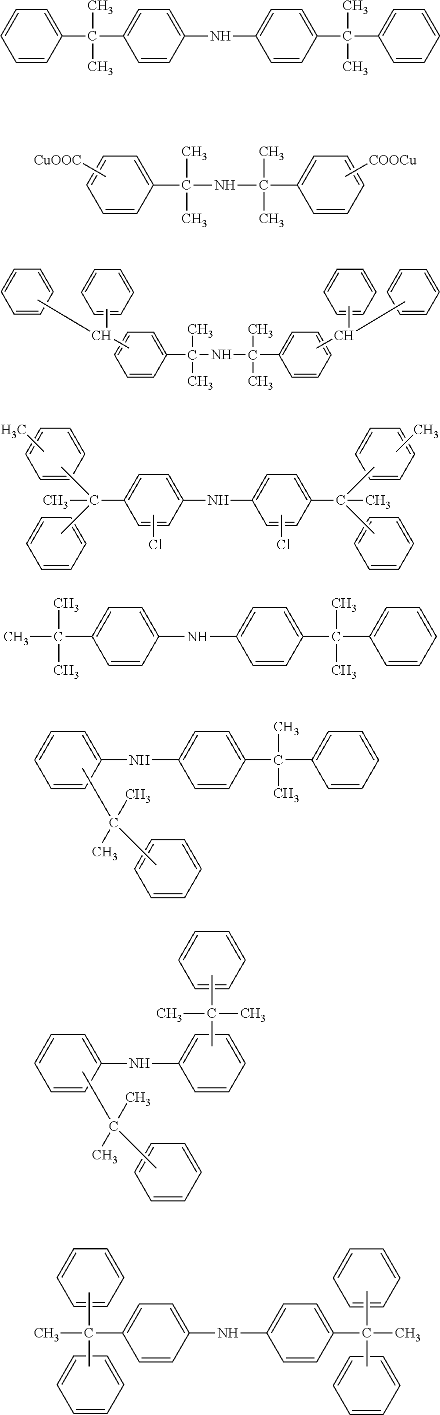

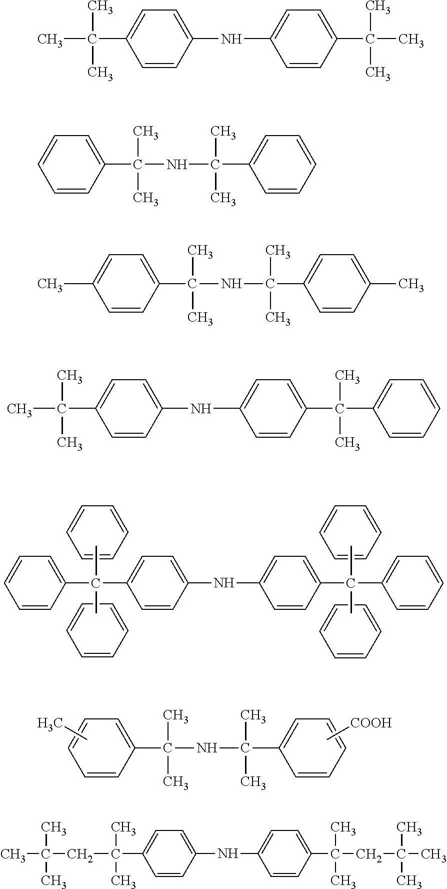

The preparation process is in accordance with the processes described in BE-A 67/05 00 120 and CA-A 9 63 594. Preferred secondary aromatic amines are diphenylamine and its derivatives, which are available commercially as Naugard® (Chemtura). These are preferred in combination with up to 2000 ppm, preferably from 100 to 2000 ppm, with preference from 200 to 500 ppm, and in particular from 200 to 400 ppm, of at least one phosphorus-containing inorganic acid or its derivatives.

Preferred acids are hypophosphorous acid, phosphorous acid, or phosphoric acid, and also salts thereof with alkali metals, particular preferably being given to sodium and potassium. Preferred mixtures are in particular hypophosphorous and phosphorous acid and their respective alkali metal salts in a ratio of from 3:1 to 1:3. Organic derivatives of said acids are preferably ester derivatives of abovementioned acids.

Molding Compositions

The thermoplastic molding compositions of the invention can be prepared by processes known per se, by mixing the starting components in conventional mixing apparatuses, such as screw extruders, Brabender mixers, or Banbury mixers, and then extruding them. The extrudate can be cooled and comminuted. It is also possible to premix individual components and then to add the remaining starting materials individually and/or likewise mixed. The mixing temperatures are generally from 230 to 320° C.

In another preferred procedure, components B) and C), and also, if appropriate, D) to F), can be mixed with a prepolymer and compounded, and pelletized. The resultant pellets are then solid-phase condensed continuously or batchwise under an inert gas at a temperature below the melting point of component A) until the desired viscosity has been reached.

The features of the thermoplastic molding compositions of the invention are good mechanical properties, and also thermal stability, and good processability/flowability.

The hyperbranched polyetheramines described above of component B) can be used according to the invention in combination with the amorphous oxides and/or oxide hydrates described above for component C), to improve the flowability and/or thermal stability of polyamides.

The thermoplastic molding compositions of the invention are themselves suitable for the production of fibers, of films, and of moldings of any type.

The invention further provides fibers, films, and moldings, obtainable from the thermoplastic molding compositions of the invention.

These are suitable for the production of fibers, of foils, and of moldings of any type. Some preferred examples are mentioned below:

Household items, electronic components, medical equipment, motor vehicle components, housings of electrical equipment, housings of electronics components in motor vehicles, wheel surrounds, door paneling, tailgate, spoilers, inlet manifolds, water tanks, housings of electrical tools.

The invention also provides the combination of separate components A), B), and C) as defined above, for use together.

### EXAMPLES

Components Used Were as Follows:

TABLE 1
Component A

| | Polyamide characterized by | |
|---|---|---|
| Starting | intrinsic viscosity VN to | |
| material | ISO 307 prior to extrusion | Constitution |
| A-1 | PA-6 with VN = 140 ml/g | 100% by weight of PA-6 |

Component B

Component B-1 used was a polyethyleneimine homopolymer having weight-average molar mass of 1300 g/mol (determined by means of gel permeation chromatography using pullulan as standard in a solution of 0.02 mol/l of formic acid and 0.2 mol/l of KCl in water as solvent) and a degree of branching DB of from 0.6 to 0.7 (Lupasol® G20 anhydrous from BASF Aktiengesellschaft).

Component C:

Preparation of Component C-1

100 g of TEOS were mixed at 60° C. for 30 minutes with 500 g of ethanol. HCl (concentration 2 mol/l in water) was then added dropwise until the pH reached 3, whereupon 352 g of water were added with uniform stirring. The reaction was then carried out for 3 hours at 60° C. The temperature was then increased to 80° C. for a further 3 hours. The resultant dispersion with SiO₂ particles was clear and had 3.5% by weight solids content. SiO₂ in powder form was obtained from this solution by drying. In a first stage, the mixture was dried for 8 hours at 80° C. and 50 mbar. The resulting powder was then dried for a further 12 hours at 100° C. in a vacuum oven.

Component C-2: Colloidal SiO₂ sol (Bindzil® CC/360 from Eka Chemicals)

The components C-1 and C-2 used had the following properties:

TABLE 2

| | | Ar | | DFT cumulative | |
|---|---|---|---|---|---|
| | Average | adsorbed | | specific surface | BET |
| | particle | at 2670 | Ar adsorbed | area of | specific |
| Component | diameter d₅₀³ | Pa¹ | at 1330 Pa¹ | micropores² | surface |
| C) | [nm] | [cm³/g] | [cm³/g] | [m²/g] | area [m²/g] |
| C-1 | 4 | 125 | 106 | 245 | 530 |
| C-2 | 8 | n.d. | n.d. | n.d. | 360 |

¹At a temperature of 87.4 K, to DIN 66135-1
²Olivier-Conklin DFT method
³Calculated from the particle size distribution obtained via dynamic light scattering

Component E:

The component E-1 used comprised glass fibers with an average diameter of from 10 to 20 micrometers and with an average length of from 200 to 250 micrometers (Ownes Corning Fiberglass OFC 1110).

Component F

The component F used comprised 0.7% by weight of Ultrabatch® (heat stabilizer comprising Cul and Kl), 1.7% by weight of Colorbatch (polyethylene with carbon black), and 1.7% by weight of calcium stearate, based on the total amount of component A-1.

The molding compositions were prepared as follows:

All the specimens were prepared via compounding in the melt in a ZSK-25 twin-screw extruder of 280° C. with 10 kg/h throughput.

A masterbatch composed of 95% by weight of component A-1 and 5% by weight of component C-1 and, respectively, C-2 was first prepared here by compounding under the conditions mentioned, component A-1 being added as cold feed, and components C-1 and, respectively, C-2 being added as hot feeds.

The resultant masterbatch together with further component A-1, and also component F, was then introduced as cold feed to the compounding process under the conditions mentioned. During the compounding process, component B-1 was also added as hot feed, and then component E-1 as hot feed. The mixing time was 2 minutes. Pellets were obtained and were dried. The water content of the pellets was less than 0.1% by weight.

The test specimens used for determination of properties were obtained by injection molding (injection temperature 280° C., melt temperature 80° C.).

MVR was determined to ISO 1133 at 270° C. with 5 kg load. Charpy impact resistance was determined with notch to ISO 179-2/1 eA at 23° C., and without notch at −30° C. to ISO 179-2/1 eU. Tensile properties were determined to ISO 527-2. Spiral length was determined at 280° C. using a 1.5 mm flow spiral. Intrinsic viscosity of the polyamides was measured to DIN 53 727 on 0.5% strength by weight solutions in 96% by weight sulfuric acid.

The results of the measurements and the constitutions of the molding compositions can be found in table 3.

TABLE 3

| | | | | | | | Melt volume- | | Charpy | | |
|---|---|---|---|---|---|---|---|---|---|---|---|
| | A-1 | B-1 | C-1 | C-2 | E-1 | Intrinsic | flow rate | Spiral | impact | Tensile | Breaking |
| | % by | % by | % by | % by | % by | viscosity | MVR | length | resistance | modulus | strength |
| Example | weight | weight | weight | weight | weight | VN [ml/g] | [g/10 min] | [cm] | [kJ/m²] | [MPa] | [MPa] |
| comp 1 | 70 | — | — | — | 30 | 135 | 45 | 26.8 | 87.9 | 9778 | 175 |
| comp 2 | 69.5 | 0.5 | — | | 30 | 130 | 77 | 36.7 | 69 | 10989 | 157 |
| comp 3 | 69 | 1 | — | | 30 | 106 | >250 | 49 | 53 | 9892 | 177 |
| comp 4 | 69.5 | — | 0.5 | | 30 | 140 | 43 | 27.5 | 92.4 | 9599 | 173 |
| comp 5¹ | 69.5 | — | | 0.5 | 30 | 135 | 50 | 27.5 | 88 | 9985 | 177 |
| 6 | 69 | 0.5 | 0.5 | | 30 | 130 | 103 | 39.3 | 74.5 | 9902 | 183 |
| 7 | 69 | 0.5 | | 0.5 | 30 | 123 | 107 | 38.3 | 72.4 | 9737 | 180 |

¹Since component B is reactive with respect to component A, the properties of examples comp 4 and comp 5 are not directly comparable.

1.-21. (canceled)

22. A thermoplastic molding composition, comprising the following components:
A) at least one thermoplastic polyamide,
B) at least one hyperbranched polyethyleneimine,
C) at least one amorphous oxide and/or oxide hydrate of at least one metal or semimetal with a number-average diameter of the primary particles of from 0.5 to 20 nm.

23. The thermoplastic molding composition of claim 22, wherein components B) and C) are comprised in a ratio by weight B/C of from 0.1 to 4, preferably from 0.2 to 2.

24. The thermoplastic molding composition of claim 22, comprising from 50 to 99.9% by weight of component A), from 0.05 to 30% by weight of component B), and from 0.05 to 20% by weight of component C), wherein the total of the percentages by weight of components A) to C) is 100% by weight.

25. The thermoplastic molding composition of claim 22, comprising, in addition thereto, at least one polyetheramine as component D).

26. The thermoplastic molding composition of claim 22, comprising from 55 to 99.85% by weight of component A), from 0.05 to 15% by weight of component B), from 0.05 to 15% by weight of component C), and from 0.05 to 15% by weight of component D), wherein the total of the percentages by weight of components A) to D) is 100% by weight.

27. The thermoplastic molding composition of claim 22, further comprising at least one fibrous filler as component E), preferably glass fibers.

28. The thermoplastic molding composition of claim 22, comprising from 15 to 98.9% by weight of component A), from 0.05 to 10% by weight of component B), from 0.05 to 10% by weight of component C), from 0 to 5% by weight of component D), and from 1 to 70% by weight of component E), wherein the total of the percentages by weight of components A) to E) is 100% by weight.

29. The thermoplastic molding composition of claim 22, further comprising further added materials as component (F).

30. The thermoplastic molding composition of claim 22, wherein component C) is obtainable from a sol.

31. The thermoplastic molding composition of claim 22, wherein component C) is obtainable via a sol-gel process.

32. The thermoplastic molding composition of claim 22, wherein component C) has a BET specific surface area to DIN 66131 of from 150 to 700 m²/g.

33. The thermoplastic molding composition of claim 22, comprising, as component C), an amorphous oxide and/or oxide hydrate of silicon with a number-average diameter of the primary particles of from 0.5 to 20 nm.

34. The thermoplastic molding composition of claim 22, wherein component C) has a number-average diameter of the primary particles of from 1 to 15 nm, preferably from 1 to 10 nm.

35. The thermoplastic molding composition of claim 22, wherein component B) has a glass transition temperature below 50° C.

36. The thermoplastic molding composition of claim 22, wherein component B) has an amine number to DIN 53176 of from 100 to 900 mg KOH/g.

37. The thermoplastic molding composition of claim 22, wherein component B) has an average of at least 3 primary amino groups per molecule.

38. The thermoplastic molding composition of claim 22, wherein component B) is obtainable via acid-catalyzed polymerization of ethyleneimine.

39. The use of highly branched or hyperbranched polyethyleneimines B) as defined in claim 22 in combination with amorphous oxides and/or oxide hydrates C), as defined in claim 22, for improving the flowability and/or thermal stability of polyamides.

40. A fiber, a foil, or a molding, obtainable from the thermoplastic molding compositions of claim 22.

41. A combination of separate components A), B), and C), as defined in claim 22, for use together.
